(19) United States
(12) Patent Application Publication
(10) Pub. No.: US 2015/0316416 A1
(43) Pub. Date: Nov. 5, 2015

(54) OPTICAL MODULE AND IMAGING SYSTEM

(71) Applicant: Seiko Epson Corporation, Tokyo (JP)

(72) Inventors: Tatsuaki FUNAMOTO, Shiojiri (JP); Tetsuo TATSUDA, Ina (JP); Akira SANO, Shiojiri (JP)

(21) Appl. No.: 14/700,613

(22) Filed: Apr. 30, 2015

(30) Foreign Application Priority Data
May 2, 2014 (JP) 2014-095036

(51) Int. Cl. G01J 3/26; G01J 3/45; G01J 3/28

(52) U.S. Cl. CPC G01J 3/26; G01J 3/2823; G01J 3/45

(57) ABSTRACT

An optical module includes a variable wavelength interference filter that has a pair of reflection films facing one another, and that emits light with a wavelength according to the gap dimensions of the pair of reflection films; an incident side optical system as a negative power lens group that guides an incident luminous flux to the variable wavelength interference filter; and a light guiding optical system as a positive power lens group on which a luminous flux passing through the variable wavelength interference filter is incident, in which the incident side optical system guides the incident luminous flux to the variable wavelength interference filter as a luminous flux in which the principal ray is parallel with respect to the optical axis (central optical axis) orthogonal to the pair of reflection films and that is scattered with respect to the principal ray, and the light guiding optical system makes the luminous flux scattered with respect to the principal ray a parallel luminous flux.

### BACKGROUND

1. Technical Field

The present invention relates to an optical module and an imaging system.

2. Related Art

In the related art, a Fabry-Perot interference filter (interference filter) in which a pair of reflection films face one another and a predetermined wavelength from incident light passes through in a case in which the light is strengthened by multiple interference due to the pair of reflection films is known. An imaging device that images a spectroscopic image and is provided with such an interference filter, an imaging element and an imaging optical system that forms an image of light passing through the interference filter on the imaging element is known (for example, JP-A-2009-141842).

However, the imaging device disclosed in JPA-2009-141842 has an interference filter built-in, and the imaging optical system should be designed with respect to the characteristics of the interference filter. That is, because the peak wavelength of interference light in the interference filter shifts according to the angle of the light that is incident, it is necessary for the light to be incident at a predetermined angle (for example, 90 degrees) with respect to the interference filter in order for the spectral precision of the interference filter to be improved. Accordingly, the imaging optical system should be designed in order that light incident at a predetermined angle with respect to the interference filter and passing through the interference filter forms an image on the imaging element, and a problem arises in that the costs incurred in design and manufacturing the imaging device increase.

Because the imaging optical system is designed with respect to the characteristics of the interference filter, there is concern of being unsuitable to applications (for example, imaging of state in which spectroscopy is not performed) other than imaging of a spectroscopic image, thereby lowering the versatility. In this way, it is difficult to suppress cost increases and lowering of the versatility while still being able to acquire a spectroscopic image with the imaging device.

### SUMMARY

An advantage of some aspects of the invention is to provide an optical module and imaging system able to acquire a spectroscopic image regardless of the configuration of an imaging device.

According to an aspect of the invention, there is provided an optical module including an interference filter that has a pair of reflection films facing one another, and that emits light with a wavelength according to the gap dimensions of the pair of reflection films; a negative power lens group that guides an incident luminous flux to the interference filter; and a positive power lens group on which a luminous flux passing through the interference filter is incident, in which the negative power lens group guides the incident luminous flux to the interference filter as a luminous flux in which a principal ray is parallel with respect to a central optical axis orthogonal to the pair of reflection films and which is scattered with respect to the principal ray, and the positive power lens group makes the luminous flux scattered with respect to the principal ray a parallel luminous flux.

In the invention, it is possible to extract light centered on a target wavelength from light that is incident by guiding a luminous flux so that the optical axis of the principal ray becomes parallel with respect to the central optical axis of the interference filter through the negative power lens group.

After the optical axis of the principal ray is guided to the interference filter so as to be parallel with respect to the central optical axis of the interference filter through the negative power lens group, the luminous flux in which luminous flux passing through the interference filter is scattered with respect to the principal ray by the positive power lens group is made a parallel luminous flux. In this case, each luminous flux is irradiated from the positive power lens group as a parallel luminous flux with an angle according to the angle with respect to the central optical axis when incident on the negative power lens group. According to such a configuration, it is possible to form an image with light diffracted from incident light of the optical module for the target wavelength with the imaging optical system of the imaging device, regardless of the configuration of the image forming optical system of the imaging device connected to the image side of the optical module.

As above, by attaching the optical module of the invention to the object side of the image forming optical system of the imaging device, it is possible to acquire a spectroscopic image by the imaging device, regardless of the configuration of the imaging device.

In the optical module according to the aspect, it is preferable that the negative power lens group guides the luminous flux scattered within a predetermined angle with respect to the principal ray to the interference filter.

Here, the angle in the luminous flux scattered with respect to the principal ray is a spreading angle (single side gradient) with respect to the principal ray of the luminous flux. The predetermined angle is the upper limit value of the angle in which the value of the half-value width of the peak of the interference light of the interference filter is a permitted value or more. In the interference filter, when the spreading angle of the scattered luminous flux increases, the half-value width increases. That is, the upper limit value of the half-value width is set according to the desired resolving power, and the upper limit value of the spreading angle is set according to the upper limit value of the half-value width.

In the invention, by making the spreading angle of the luminous flux within the predetermined angle, it is possible for the half-value width of the peak of the interference light of the interference filter to be made the permitted value or more. In so doing, it is possible to suppress lowering of the resolving power of the measured wavelength due to increases in the half-value width.

In the optical module according to the aspect, it is preferable that the predetermined angle is 5 degrees.

In the invention, by making the spreading angle (single side gradient) 5 degrees or less, it is possible make the half-value width the permitted value or more (for example, variation amount when the spreading angle is 0 degrees is several percent or less) in the red wavelength range or the infrared wavelength range. In so doing, it is possible to more reliably suppress lowering of the resolving power of the measured wavelength due to increasing of the half-value width in the wavelength region.

According to another aspect of the invention, there is provided an imaging system including an optical module that includes an interference filter that has a pair of reflection films facing one another, and that emits light with a wavelength according to the gap dimensions of the pair of reflection films, a negative power lens group that guides an incident luminous flux to the interference filter, and a positive power lens group on which a luminous flux passing through the interference filter is incident; and an imaging device which includes an imaging element that images an image and image forming optical system that images light from the optical module on the imaging element, and to which the optical module is detachably attached, in which the negative power lens group guides the incident luminous flux to the interference filter as a luminous flux in which a principal ray is parallel with respect to a central optical axis orthogonal to the pair of reflection films and which is scattered with respect to the principal ray, and the positive power lens group makes the luminous flux scattered with respect to the principal ray a parallel luminous flux.

According to the aspect of the invention, by attaching an optical module to the object side of the image forming optical system of the imaging device similarly to the invention of the optical module, it is possible to acquire a spectroscopic image by the imaging device, regardless of the configuration of the imaging device. That is, the image forming optical system of the imaging device may be designed with respect to the interference filter, and it is possible to use a generally distributed device having an imaging capability, such as a digital camera or smartphone, as the imaging device. Accordingly, it is possible to provide a highly versatile imaging system capable of suppressing cost increases.

### BRIEF DESCRIPTION OF THE DRAWINGS

The invention will be described with reference to the accompanying drawings, wherein like numbers reference like elements.

FIG. 1 is a view showing the schematic configuration of a spectroscopic camera according to an embodiment of the invention.

FIG. 2 is a block diagram showing the schematic configuration of a spectroscopic camera according to an embodiment of the invention.

FIG. 3 is a view showing an optical path of a luminous flux guided by a spectroscopic optical system and an image forming optical system.

FIG. 4 is a plan view showing a schematic configuration of a variable wavelength interference filter.

FIG. 5 is a cross-sectional view showing a schematic configuration of a variable wavelength interference filter.

FIG. 6 is a view schematically showing the light beam shape of an inverse cone type luminous flux irradiated from an incident side optical system.

FIG. 7 is a view showing the half-value width of the peak of transmitted light passing through the variable wavelength interference filter with respect to a single side gradient of the inverse cone luminous flux.

FIG. 8 is a view schematically showing the inverse cone luminous flux in which a principal ray is inclined with respect to a central optical axis.

FIG. 9 is a view showing the peak wavelength fluctuation amount of transmitted light of the variable wavelength interference filter with respect to the inclination angle of the principal ray.

### DESCRIPTION OF EXEMPLARY EMBODIMENTS

Below, an embodiment of the invention will be described with reference to the drawings.

### Schematic Configuration of Spectroscopic Camera

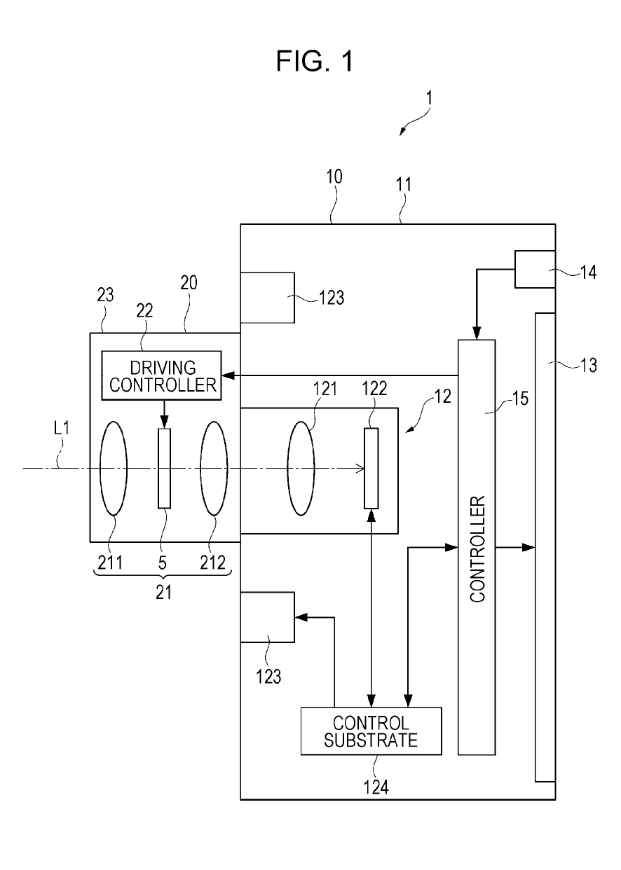

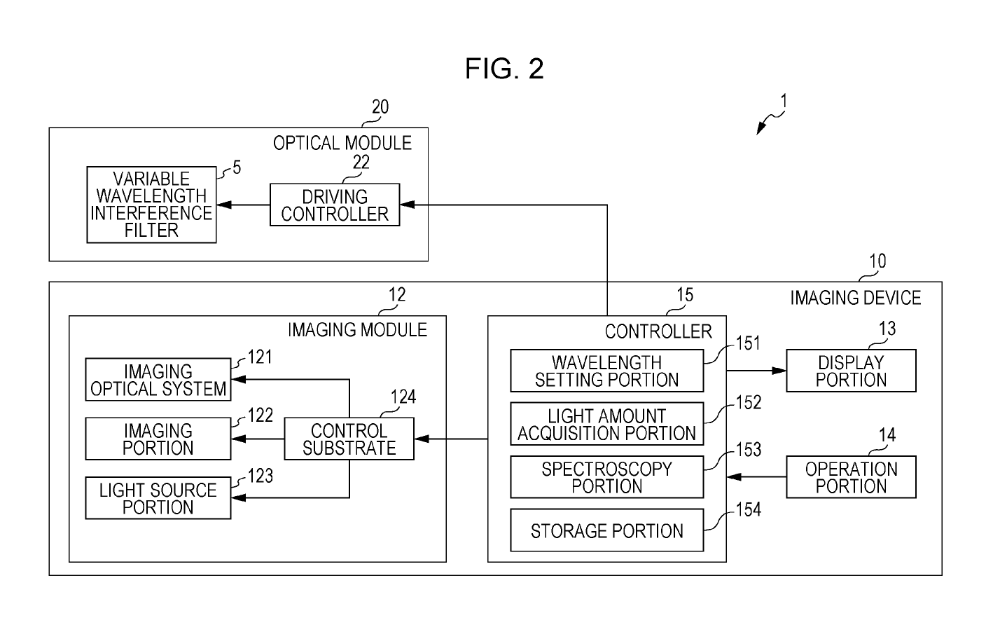

FIG. 1 is a schematic view showing the configuration of a spectroscopic camera according to an embodiment of the invention. FIG. 2 is a block diagram showing a schematic configuration of the spectroscopic camera.

The spectroscopic camera 1 is a device that corresponds to the imaging system of the invention, captures spectroscopic images with respect to a plurality of wavelengths of an imaging target, and acquires a diffracted spectrum based on these spectroscopic images.

The spectroscopic camera 1 of the embodiment includes an imaging device 10, and an optical module 20 configured to be detachable with respect to the imaging device 10, as shown in FIG. 1. In the spectroscopic camera 1, light from the measurement target (measurement target light) is diffracted by the optical module 20, and a spectroscopic image is acquired by capturing the diffracted light with the imaging device 10.

### Configuration of Imaging Device

The imaging device 10 includes an outer housing 11, an imaging module 12, a display portion 13, an operation portion 14 and a controller 15, as shown in FIG. 1.

The outer housing 11 stores each member that configures the imaging device 10. Although not shown, the outer housing 11 includes an attachment member that makes the optical module 20 detachable.

### Configuration of Imaging Module

The imaging module 12 receives incident light according to the control by the controller 15, thereby acquiring an image. The imaging module 12 includes an image forming optical system 121, an imaging portion 122 that receives incident light, a light source portion 123, and a control substrate 124.

Although described in detail later, the image forming optical system 121 is configured by a plurality of lenses, and forms an image of a target object on the imaging portion 122. The image forming optical system 121 is configured with a lens gap that is adjustable according to control by the controller 15 or a user operation, and is able to auto-focus or enlarge and reduce an image.

The imaging portion 122 corresponds to the imaging element of the invention, and is able to use an image sensor or the like, such as a CCD or CMOS. The imaging portion 122 includes a photoelectric element corresponding to each pixel, and outputs a spectroscopic image (image signal) in which the light amount received by each photoelectric element is made the light amount of each pixel to the controller 15 via the control substrate 124.

The light source portion 123 is a light source such as an LED that radiates light including the measurement target wavelength. The light source portion 123 is connected to the control substrate 124, and is lit or extinguished according to control by the controller 15 or a user operation.

The control substrate 124 is a circuit substrate that controls the operation of the imaging module 12, and is connected to the image forming optical system 121, the imaging portion 122, the light source portion 123, and the like, as shown in FIG. 2. The control substrate 124 controls the operation of each configuration based on control signals input from the controller 15. When a zoom operation is performed by the user, the control substrate 124 moves a predetermined lens of the image forming optical system 121, or varies the aperture diameter of the aperture. Lighting control of the light source portion 123 and imaging control of the imaging portion 122 are executed based on the control signals from the controller 15.

### Configuration of Display Portion

The display portion 13 is provided facing the display window of the outer housing 11. Any display may be used as the display portion 13 as long as the configuration is able to display images, and possible examples include liquid crystal panels and organic EL panels. The display portion 13 of the embodiment is configured to include a touch panel, and the touch panel may be integrated with the operation portion 14.

### Configuration of Operation Portion

The operation portion 14, as described above, is configured by a shutter button provided in the outer housing 11, a touch panel provided in the display portion 13, or the like. When an input operation is performed by a user, the operation portion 14 outputs an operation signal according to the input operation to the controller 15. The operation portion 14 is not limited to the above configuration, and may be a configuration or the like in which a plurality of operation buttons or the like is provided instead of a touch panel.

### Configuration of Controller

The controller 15 is configured by a CPU, a memory, and the like being combined, and controls the overall operation of the spectroscopic camera 1. The controller 15 includes a wavelength setting portion 151, a light amount acquisition portion 152, a spectroscopy portion 153, and a storage portion 154, as shown in FIG. 2.

The wavelength setting portion 151 sets the target wavelength of light extracted by the variable wavelength interference filter 5, described later, and outputs a control signal indicating extraction of the set target wavelength from the variable wavelength interference filter 5 to a driving controller 22, described later.

The light amount acquisition portion 152 acquires the light amount of light of the target wavelength passing through the variable wavelength interference filter 5 based on the spectroscopic image acquired by the imaging portion 122.

The spectroscopy portion 153 measures the spectral characteristics of measurement target light based on the light amount acquired by the light amount acquisition portion 152.

The storage portion 154 stores an OS for controlling the overall operation of the spectroscopic camera 1, applications and programs for realizing various functions, and a variety of data. A temporary storage region that temporarily stores the acquired spectroscopic image, component analysis results and the like is provided in the storage portion 154.

As the variety of data, V-λ data that indicates the relationship of the wavelength of light passing through the variable wavelength interference filter 5 with respect to the driving voltage applied to an electrostatic actuator 56, described later, of the variable wavelength interference filter 5 is stored in the storage portion 154. A program or the like for setting the measurement target wavelength of the variable wavelength interference filter 5 is stored in the storage portion 154.

### Configuration of Optical Module

The optical module 20 includes the variable wavelength interference filter 5, a spectroscopic optical system 21 that diffracts incident light, a driving controller 22 that sets the wavelength of light passing through the variable wavelength interference filter 5, and a module housing 23 that stores the spectroscopic optical system 21 and the driving controller 22, as shown in FIG. 1.

### Configuration of Spectroscopic Optical System

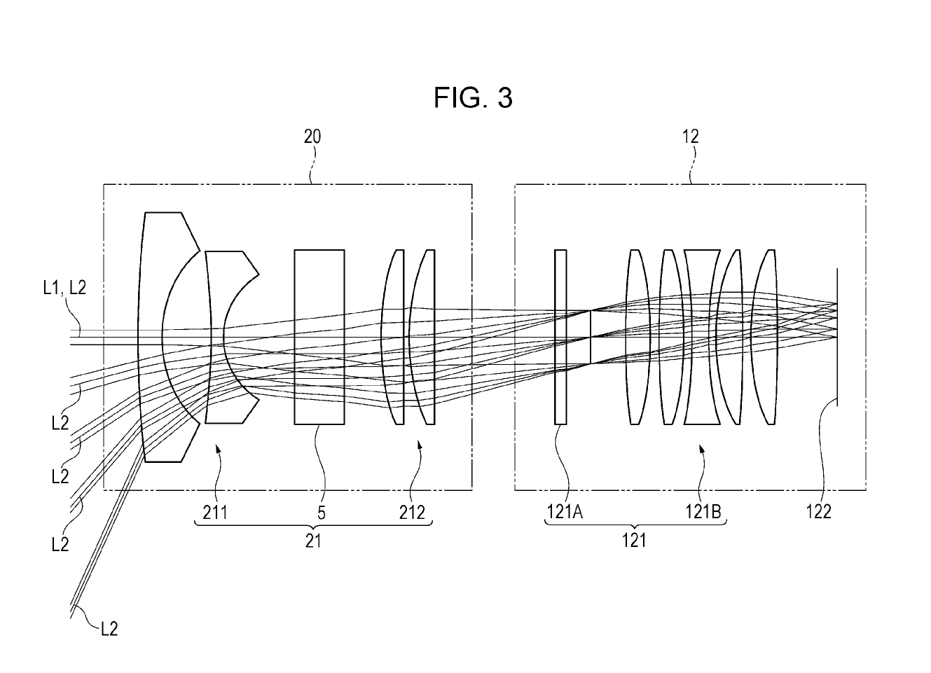

FIG. 3 is a drawing showing the schematic configuration of a spectroscopic optical system 21 provided in the optical module 20 and the image forming optical system 121 provided in the imaging module 12.

The spectroscopic optical system 21 shown in FIG. 3 is configured as an afocal optical system provided with the variable wavelength interference filter 5, an incident side optical system 211, and a light guide optical system 212, as described above. The spectroscopic optical system 21 causes light to be incident on the variable wavelength interference filter 5 in a state where the principal ray of the incident luminous flux is parallel with respect to the optical axis L1 (corresponds to central optical axis in the invention) orthogonal to each reflection film 54 and 55, described later, of the variable wavelength interference filter 5 by means of the incident side optical system 211. Thereafter, the spectroscopic optical system 21 causes the transmitted luminous flux of the variable wavelength interference filter 5 to be incident on the image forming optical system 121 on the imaging device 10 side as a parallel luminous flux by means of the light guide optical system 212. The incident side optical system 211 and the light guide optical system 212 will be described in detail later.

### Configuration of Variable Wavelength Interference Filter

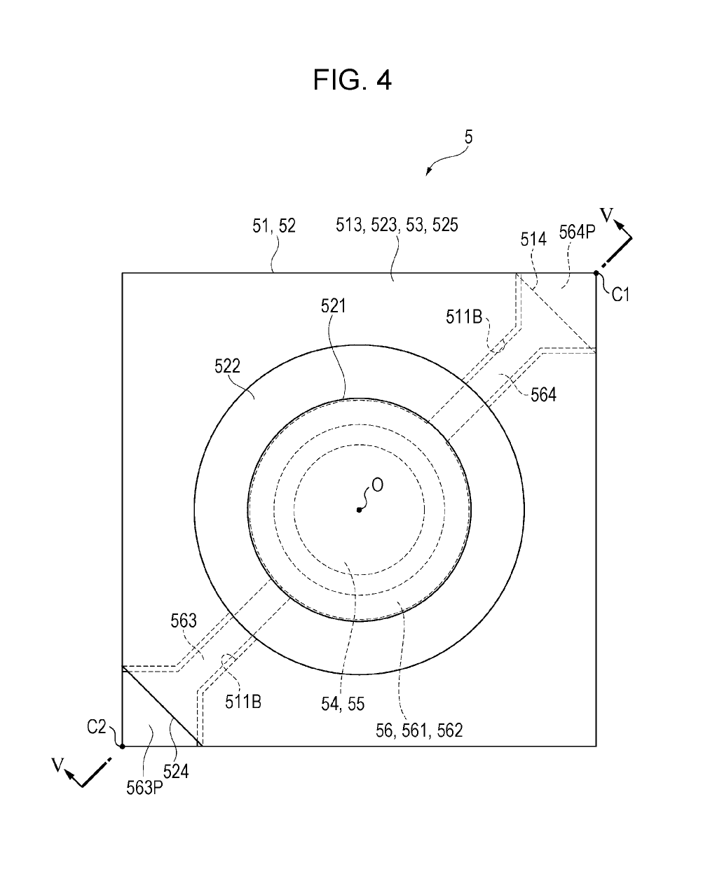

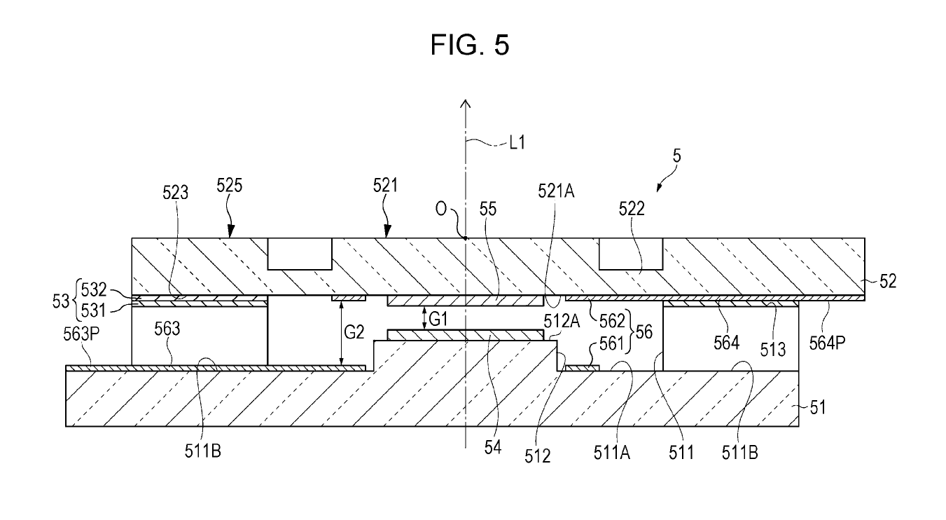

FIG. 4 is a plan view showing a schematic configuration of a variable wavelength interference filter. FIG. 5 is a cross-sectional view of the variable wavelength interference filter when seen in cross-section along the line V-V in FIG. 4.

The variable wavelength interference filter 5 corresponds to the spectroscopic filter of the invention, and is a variable wavelength-type Fabry-Perot etalon. The variable wavelength interference filter 5 is a rectangular optical member and includes a fixed substrate 51 formed with a thickness dimension of approximately 500 μm and a movable substrate 52 formed with a thickness dimension of approximately 200 μm. The fixed substrate 51 and the movable substrate 52 are each formed by various glasses such as soda glass, crystalline glass, quartz glass, lead glass, potassium glass, borosilicate glass, and non-alkaline glass, crystals or the like. The fixed substrate 51 and movable substrate 52 are integrally formed by a bonding film 53 (first bonding film 531 and second bonding film 532) in which a first bonding portion 513 of the fixed substrate 51 and a second bonding portion 523 of the movable substrate are configured by a plasma polymer film or the like with siloxane as a main component.

A fixed reflection film 54 is provided on the fixed substrate 51 and a movable reflection film 55 is provided on the movable substrate 52. The fixed reflection film 54 and the movable reflection film 55 are arranged opposed with a gap G1 interposed. An electrostatic actuator 56 used in adjusting (modifying) the dimensions of the gap G1 is provided in the variable wavelength interference filter 5.

The planar center points O of the fixed substrate 51 and the movable substrate 52 match the center points of the fixed reflection film 54 and the movable reflection film and match the center point of a movable portion 521, described later, in plan view (below, referred to as filter plan view) as shown in FIG. 4 in which the variable wavelength interference filter 5 is viewed from the substrate thickness direction of the fixed substrate 51 (movable substrate 52).

### Configuration of Fixed Substrate

An electrode arrangement groove 511 and a reflection film installation portion 512 are formed by etching on the fixed substrate 51. The fixed substrate 51 is formed to have a large thickness dimension with respect to the movable substrate 52, and there is no bending of the fixed substrate 51 due to the electrostatic attractive force when a voltage is applied between the fixed electrode 561 and the movable electrode 562 or the internal stress of the fixed electrode 561.

A notch portion 514 is formed in the apex C1 of the fixed substrate 51, and a movable electrode pad 564P, described later, is exposed to the fixed substrate 51 side of the variable wavelength interference filter 5.

The electrode arrangement groove 511 is formed with an annular shape in which the planar center point O of the fixed substrate 51 is the center in filter plan view. The reflection film installation portion 512 is formed by projecting from the central portion of the electrode arrangement groove 511 to the movable substrate 52 side in plan view. The groove bottom surface of the electrode arrangement groove 511 becomes the electrode installation surface 511A on which the fixed electrode 561 is arranged. The projected tip surface of the reflection film installation portion 512 becomes the reflection film installation surface 512A.

In the fixed substrate 51, an electrode extraction groove 511B is provided extending toward the apexes C1 and C2 on the outer peripheral edge of the fixed substrate 51 from the electrode arrangement groove 511.

A fixed electrode 561 that configures the electrostatic actuator 56 is provided on the electrode installation surface 511A of the electrode arrangement groove 511. More specifically, the fixed electrode 561 is provided in a region facing the movable electrode 562 of the movable portion 521, described later, from the electrode installation surface 511A. A configuration may be used in which an insulating film is layered on the fixed electrode 561 in order to ensure the insulating properties between the fixed electrode 561 and the movable electrode 562.

A fixed extraction electrode 563 that extends from the outer peripheral edge of the fixed electrode 561 in the apex C2 direction is provided on the fixed substrate 51. An extension tip portion (part positioned on the apex C2 of the fixed substrate 51) of the fixed extraction electrode 563 configures a fixed electrode pad 563P connected to the driving controller 22.

In the embodiment, although a configuration is shown in which one fixed electrode 561 is provided on the electrode installation surface 511A, a configuration (double electrode configuration) or the like in which two electrodes that are concentric with the planar center point O as a center are provided may be used.

The reflection film installation portion 512, is formed on the same axis as the electrode arrangement groove 511 in a substantially columnar shape in which the diameter dimension is smaller than the electrode arrangement groove 511 as described above, and a reflection film installation surface 512A that faces the movable substrate 52 of the reflection film installation portion 512 is provided.

As shown in FIG. 5, the fixed reflection film 54 is installed on the reflection film installation portion 512. It is possible to use a metal film such as Ag or an alloy film such as an Ag allow as the fixed reflection film 54. A dielectric multilayer film may be used in which the high refraction layer is TiO₂ and the low refraction layer is SiO₂. A reflection film in which a metal film (or alloy film) is layered on a dielectric multilayer film, a reflection film in which a dielectric multilayer film is layered on a metal film (or alloy film), a reflection film in which a single layer refraction film (such as TiO₂ or SiO₂) and a metal film (or alloy film) are layered or the like may be used.

An anti-reflection film may be formed at a position corresponding to the fixed reflection film 54 on the light incident surface (surface on which the fixed reflection film 54 is not provided) of the fixed substrate 51. It is possible for the anti-reflection film to be formed by alternately layering the low refractive index film and the high refractive index film, lowering the reflectivity of visible light by the surface of the fixed substrate 51 and increasing the transmissivity.

Among the surface of the fixed substrate 51 facing the movable substrate 52, the surface on which the electrode arrangement groove 511, the reflection film installation portion 512, and the electrode extraction groove 511B are not formed by etching configures the first bonding portion 513. A first bonding film 531 is provided on the first bonding portion 513, and the fixed substrate 51 and the movable substrate 52 are bonded as described above by the first bonding film 531 being bonded to a second bonding film 532 provided on the movable substrate 52.

### Configuration of Movable Substrate

The movable substrate 52 includes, in filter plan view shown in FIG. 4, a circular movable portion 521 with the planar center point O as a center, a holding portion 522 that holds the movable portion 521 on the same axis as the movable portion 521, and a substrate outer peripheral portion 525 provided on the outside of the holding portion 522.

A notch portion 524 corresponding to the apex C2 is formed on the movable substrate 52 as shown in FIG. 4, and the fixed electrode pad 563P is exposed when the variable wavelength interference filter 5 is viewed from the movable substrate 52 side.

The movable portion 521 is formed with a larger thickness dimension than the holding portion 522, and in the embodiment, is formed with the same dimension as the thickness dimension as the movable substrate 52. The movable portion 521 is formed with a larger diameter dimension than at least the diameter dimension of the outer peripheral edge of the reflection film installation surface 512A in filter plan view. A movable electrode 562 and a movable reflection film 55 are provided on the movable portion 521.

Similarly to the fixed substrate 51, an anti-reflection film may be formed on the surface of the opposite side of the movable portion 521 to the fixed substrate 51. It is possible for such an anti-reflection film to be formed by alternately layering the low refractive index film and the high refractive index film, lowering the reflectivity of visible light by the surface of the movable substrate 52 and increasing the transmissivity.

The movable electrode 562 faces the fixed electrode 561 with the gap G2 interposed and is formed in a circular shape that is the same shape as the fixed electrode 561. The movable electrode 562 configures electrostatic actuator 56 along with the fixed electrode 561. A movable extraction electrode 564 that extends from the outer peripheral edge of the movable electrode 562 toward the apex C1 of the movable substrate 52 is included on the movable substrate 52. An extension tip portion (part positioned on the apex C1 of the movable substrate 52) of the movable extraction electrode 564 configures a movable electrode pad 564P connected to the driving controller 22.

The movable reflection film 55 is provided facing the fixed reflection film 54 with a gap G1 interposed at the central portion of the movable surface 521A of the movable portion 521. A reflection film with the same configuration as the above-described fixed reflection film 54 is used as the movable reflection film 55.

In the embodiment, as described above, although an example where the gap G2 is bigger than the dimension of the gap G1 is shown, there is no limitation thereto. For example, in cases and the like where infrared rays or far infrared rays are used as the measurement target light, a configuration may be used where the dimensions of the gap G1 becomes larger than the dimensions of the gap G2 according to the wavelength region of the measurement target light.

The holding portion 522 is a diaphragm that surrounds the periphery of the movable portion 521, the thickness dimension is formed smaller than the movable portion 521. Such a holding portion 522 is more easily bent than the movable portion 521, and the movable portion 521 is able to be displaced to the fixed substrate 51 side due to a slight electrostatic attractive force. In this case, because the movable portion 521 has a thickness dimension larger than the holding portion 522, and the rigidity increases, even in a case where the holding portion 522 is elongated to the fixed substrate 51 side due to the electrostatic attractive force, the variations in the shape of the movable portion 521 do not occur. Accordingly, it is possible to maintain the normally parallel state of the fixed reflection film 54 and the movable reflection film 55 without bending of the movable reflection film 55 provided on the movable portion 521 arising.

In the embodiment, although a diaphragm-like holding portion 522 is shown as an example, there is no limitation thereto, and a configuration may be used in which a beam-like holding portion is provided arranged at intervals of an equal angle with the planar center point O as a center.

The substrate outer peripheral portion 525 is provided on the outside of the holding portion 522 in filter plan view, as described above. The surface of the substrate outer peripheral portion 525 facing the fixed substrate 51 includes the second bonding portion 523 that faces the first bonding portion 513. The second bonding film 532 is provided on the second bonding portion 523, and the fixed substrate 51 and the movable substrate 52 are bonded by the second bonding film 532 being bonded to the first bonding film 531, as described above.

The variable wavelength interference filter 5 configured in this way is arranged at a predetermined position on the optical axis L1 of the spectroscopic optical system 21 so that the optical axis L1 set in the spectroscopic optical system 21 is orthogonal to each of the reflection films 54 and 55 (refer to FIG. 5).

In the embodiment, although the optical axis L1 passes through the planar center point O as shown in FIG. 5, the axis may not pass through the planar center point O, and the position of the variable wavelength interference filter 5 may be set with respect to the optical axis L1 so that the incident range of the incident luminous flux of the variable wavelength interference filter 5 at least overlaps the region facing each reflection film 54 and 55.

### Driving Controller

The driving controller 22 applies a driving voltage with respect to the electrostatic actuator 56 of the variable wavelength interference filter 5 based on a command signal from the controller 15. In so doing, an electrostatic attractive force is generated between the fixed electrode 561 and the movable electrode 562 of the electrostatic actuator 56, and the movable portion 521 is displaced to the fixed substrate 51 side. The dimension of the gap G1 of the variable wavelength interference filter 5 is set to a value corresponding to the target wavelength.

### Configuration of Incident Side Optical System

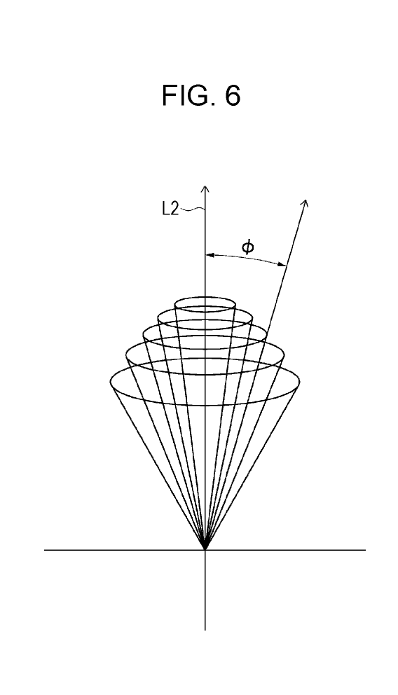

As shown in FIG. 3, the incident side optical system 211 is a negative power lens group that includes optical components such as a plurality of lenses. The incident side optical system 211 converts the luminous flux corresponding to each point of the imaging target to an inverse cone luminous flux (refer to FIG. 6) and, along therewith, evens out the principal ray of each luminous flux to a substantially parallel state with respect to the optical axis L1, and guides the luminous flux to the variable wavelength interference filter 5.

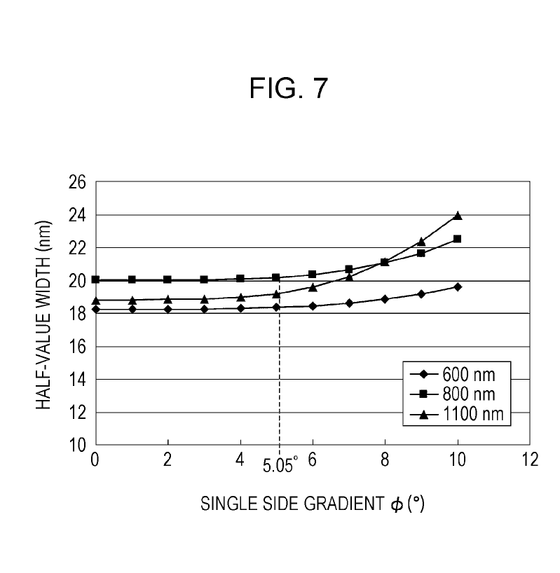

FIG. 6 is a schematic view showing an example of an inverse cone luminous flux. FIG. 7 is a graph indicating an example of the relationship between the single side gradient φ of the inverse cone luminous flux and the half-value width (nm) of transmitted light passing through from the variable wavelength interference filter 5. In FIG. 7, each of the 600 nm, 800 nm and 1100 nm wavelengths is shown as measurement target wavelengths.

The incident side optical system 211 converts the luminous flux from each point of the imaging target to a luminous flux scattering at a predetermined spreading angle (single side gradient φ shown in FIG. 6) with respect to the principal ray, as described above.

Here the half-value width with respect to the peak of the transmitted light passing through from the variable wavelength interference filter 5 varies little in a case where the value of the single side gradient φ is 5 degrees or less, as shown in FIG. 7. Meanwhile, variations in the half-value width increase when the value of the single side gradient φ exceeds 5 degrees. Accordingly, it is preferable to set the value of the single side gradient φ to 5 degrees or less, and it is possible to suppress lowering of the resolving power of the variable wavelength interference filter 5 due to fluctuations in the half-value width.

The permitted range of the single side gradient φ differs according to the measurement target wavelength. For example, the variation amount of the half-value width with respect to the variations in the single side gradient φ is larger for a case where the measurement target wavelength value is 1100 nm than a case where the wavelength is 600 nm. In the example shown, the fluctuation amount exceeds 20% in a case where the measurement target wavelength 1100 nm in contrast to the fluctuation amount of the half-value width is 20% or less in cases where the single side gradient φ is 10 degrees in cases where the measurement target wavelength is 600 nm and 800 nm.

Accordingly, it is possible to set the half-value width of the transmitted light to a permitted range in the measurement conditions by setting the upper limit value of the value of the single side gradient φ according to the measurement conditions such as the measurement target wavelength region and characteristics of the variable wavelength interference filter 5. For example, it is possible to set the half-value width of the transmitted light to a permitted range by setting the value of the single side gradient φ to 5 degrees or less, in a wide range of the red wavelength region (for example, wavelength region of 600 to 800 nm) and the infrared region (for example, wavelength region of 800 nm or higher).

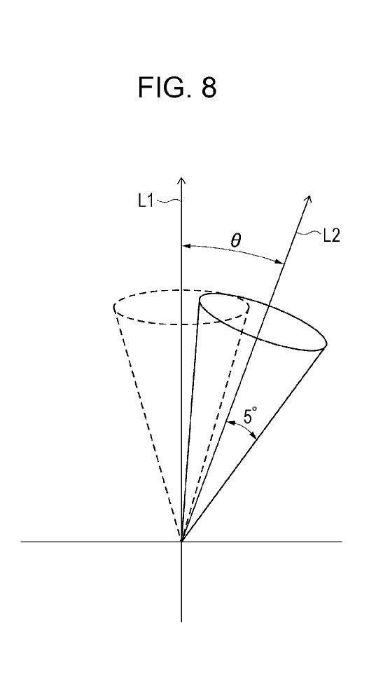

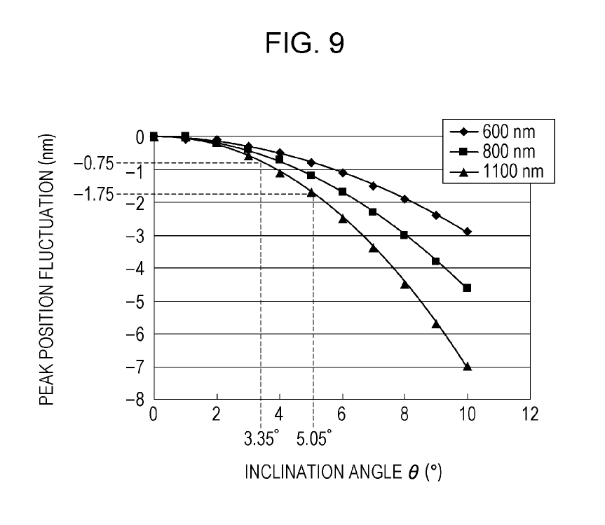

FIG. 8 is a view schematically showing the inverse cone luminous flux in which the principal ray L2 is inclined with respect to the optical axis L1. FIG. 9 is a view showing the relationship between the inclination angle θ of the principal ray L2 with respect to the optical axis L1 and the peak wavelength fluctuation amount of transmitted light passing through the variable wavelength interference filter 5. In FIG. 9, the single side gradient φ of the inverse cone luminous flux incident on the variable wavelength interference filter is set to 5 degrees as shown in FIG. 8.

The incident side optical system 211 guides the principal ray of the luminous flux incident as described above to the variable wavelength interference filter 5 in a state of being substantially parallel to the optical axis L1. In other words, the incident side optical system 211 causes the incident luminous flux to be incident on the variable wavelength interference filter 5 so that the principal ray is substantially orthogonal to the fixed reflection film 54. As shown in FIG. 8, in a case of a relationship where the principal ray L2 of the inverse cone luminous flux has an inclination angle θ with respect to the optical axis L1, the inclination angle θ of the principal ray L2 with respect to the optical axis L1 is also the incident angle on the variable wavelength interference filter 5.

As shown in FIG. 9, the fluctuation amount of the peak wavelength of the transmitted light passing through the variable wavelength interference filter 5 increases according to the increasing of the inclination angle θ (that is, the incident angle). The fluctuation amount of the peak wavelength also increases according to the increasing of the wavelength. Accordingly, in the lens design of the incident side optical system 211, with respect to the wavelength regions not passing through the variable wavelength interference filter 5, the inclination angle θ of the principal ray L2 may be set, as appropriate, by being able to permit fluctuation amount of the any peak wavelength.

For example, in a case where 1100 nm light is incident on the variable wavelength interference filter 5, the peak wavelength fluctuates by 1 nm by the incident angle shifting 2.7 degrees. Accordingly, when diffracted by the variable wavelength interference filter 5 with respect to the wavelength region of 1100 nm or less, in a case where the fluctuation amount of the peak wavelength due to the incident angle of the principal ray show is to be suppressed to 1 nm or less, the inclination of the optical axis L1 of the principal ray is set to within 3.35 degrees.

### Configuration of Light Guide Optical System

The light guide optical system 212 is a positive power lens group that includes optical components such as a plurality of lenses, as shown in FIG. 3. The light guide optical system 212 makes transmitted light from the variable wavelength interference filter 5 made a luminous flux irradiated by the incident side optical system 211 that is the negative power lens group a parallel luminous flux.

The light guide optical system 212 modifies the angle of the parallel luminous flux so that the angle with respect to the optical axis L1 of each luminous flux becomes an angle according to the angle with respect to the optical axis L1 of each luminous flux when incident on the incident side optical system 211. For example, the luminous flux incident on the incident side optical system 211 along the optical axis L1 is emitted from the light guide optical system 212 as a luminous flux similarly following the optical axis L1. The angle of the optical axis L1 of the luminous flux emitted from the light guide optical system 212 becomes larger as the angle with respect to the optical axis L1 increases when incident on the incident side optical system 211.

As shown in FIG. 3, the image forming optical system 121 forms an image from light from the light guide optical system 212 on the imaging portion 122 as an image of an object. The image forming optical system 121 includes a cover glass 121A and a lens group 121B including an aperture and a lens, and is configured to include a plurality of optical components. The image forming optical system 121 is configured with a lens gap that is adjustable according to control by the controller 15 or a user operation, and is able to auto-focus or enlarge and reduce an acquired image.

### Function of Spectroscopic Optical System

In the spectroscopic optical system 21 configured in this way, the principal ray L2 of each luminous flux incident on the variable wavelength interference filter 5 becomes substantially parallel to the optical axis L1 (that is, substantially orthogonal to the variable wavelength interference filter 5) by means of the incident side optical system 211 configured as a negative power lens group. In this case, each luminous flux is a luminous flux scattered at a predetermined spreading angle with respect to the principal ray. In the spectroscopic optical system 21, the luminous flux scattered as above is made a parallel luminous flux by means of the light guide optical system 212 configured as a positive power lens group.

In the spectroscopic optical system 21 of the embodiment, the angle with respect to the optical axis L1 of the parallel luminous flux emitted from the light guide optical system 212 attains a value according to the angle with respect to the optical axis L1 of the corresponding incident luminous flux from among the incident luminous flux incident on the incident side optical system 211. Specifically, among the luminous flux incident on the incident side optical system 211, as much light is emitted from the light guide optical system 212 as a luminous flux with a larger angle with respect to the optical axis L1 as the luminous flux with a large angle with respect to the optical axis L1. Accordingly, an image of an object is formed on the imaging portion 122 by the parallel luminous flux emitted from the light guide optical system 212 being incident on the image forming optical system 121 of the imaging device 10.

In the spectroscopic optical system 21, the incident side optical system 211 configured as a negative power lens group and the light guide optical system 212 configured as a positive power lens group are provided, and the focal length of the image forming optical system of the imaging device 10 is shortened. In so doing, the angle of view of the spectroscopic camera 1 becomes larger than the angle of view set in advance in the imaging device 10. That is, the spectroscopic optical system 21 also function as a wide angle conversion lens.

### Action and Effects of Embodiment

In the spectroscopic camera 1 configured as described above, the optical module 20 is able to extract light centered on the measurement target wavelength from the incident luminous flux by guiding the luminous flux so that the optical axis of the principal ray becomes parallel with respect to the optical axis L1 with the incident side optical system 211 as a negative power lens group.

After being guided to the variable wavelength interference filter 5 so that the optical axis of the principal ray becomes parallel with respect to the optical axis L1 of the variable wavelength interference filter 5 by the incident side optical system 211, the luminous flux in which the luminous flux passing through the variable wavelength interference filter 5 is scattered with respect to the principal ray by the light guide optical system 212 as positive power lens group becomes a parallel luminous flux. In this case, each luminous flux is emitted from the light guide optical system 212 as a parallel luminous flux with an angle (inclination with respect to the optical axis L1) according to the inclination angle θ with respect to the optical axis L1 when incident on the light guide optical system 212. In so doing, imaging is possible by the image forming optical system 121 of the imaging device 10, regardless of the configuration of the image forming optical system 121 of the imaging device 10 connected to the image side.

As above, by attaching the optical module 20 to the object side of the image forming optical system 121 of the imaging device 10, it is possible to acquire a spectroscopic image with the imaging device 10, regardless of the configuration of the imaging device 10.

The image forming optical system 121 of the imaging device 10 may be designed with respect to the variable wavelength interference filter 5, and it is possible to use a generally distributed device having an imaging capability, such as a digital camera or smartphone, as the imaging device 10. Accordingly, it is possible to provide a spectroscopic camera 1 as a highly versatile imaging system capable of suppressing cost increases.

In the optical module 20, the image forming optical system 121 is designed so that the spreading angle (single side gradient φ) of the luminous flux scattered by the image forming optical system 121 falls within a predetermined angle. In so doing, it is possible to make the half-value width of the peak of interference light of the interference filter be a permitted value or higher. Accordingly, it is possible to suppress lowering of the resolving power of the measured wavelength due to increases in the half-value width.

In particular, it is possible to make the half-value width be a permitted value in the red wavelength region or the infra red wavelength region by making the spreading angle (single side gradient) 5 degrees or lower. In so doing, it is possible to more reliably suppress lowering of the resolving power of the measured wavelength due to increasing of the half-value width in the wavelength region.

### Modification of Embodiments

The invention is not limited by the above embodiments and modifications, improvements and the like able to achieve the object of the invention are included in the invention.

For example, although in each embodiment, the spectroscopic camera configured by attaching the optical module of the invention to an imaging device as a spectroscopic system was given as an example, the invention is not limited thereto. For example, it is possible to also apply the invention to spectrometry device that acquires a diffracted spectrum based on the measurement results or an analysis device that executes component analysis and the like of an imaged target.

In the embodiments, a configuration may be used in which a retreating mechanism that retreats the variable wavelength interference filter 5 from an optical axis L1 of the spectroscopic optical system 21 of the optical module 20 is included. In such a configuration, it is possible for the variable wavelength interference filter 5 to be retreated from the optical axis L1 of the spectroscopic optical system 21 having a function as a wide angle conversion lens as described above. In so doing, it is possible for the spectroscopic optical system 21 to also function as a simple wide angle conversion lens without a spectroscopy function. Switching between having and not having a spectroscopy function in the spectroscopic optical system 21 becomes easy. In so doing, in the spectroscopic camera 1, it is possible to easily switch between a normal mode that images an ordinary imaged image, and a spectroscopic mode that images a spectroscopic image. In so doing, it is easy to also use the spectroscopic camera 1 as an ordinary camera, and it is possible for the versatility to be greatly improved.

In the embodiments, although an example was given of a configuration in which the controller 15 included in the imaging device 10 controls the operation of the variable wavelength interference filter 5, the invention is not limited thereto. For example, the optical module 20 may be configured to include a wavelength setting portion 151.

In the embodiments, although an example of a configuration in which a driving controller 22 that applies a driving voltage to the variable wavelength interference filter 5 is provided in the optical module 20 was given, the invention is not limited thereto. For example, the imaging device 10 may be configured to include a driving controller 22.

In the embodiments, a configuration may be used in which the variable wavelength interference filter 5 is assembled to the optical module 20 in a state of being accommodated in a package. In this case, by vacuum sealing inside the package, it is possible for the driving responsiveness when the voltage is applied to the electrostatic actuator 56 of the variable wavelength interference filter 5 to be improved.

In the embodiment, although the electrostatic actuator 56 in which the movable portion 521 is displaced by the holding portion 522 being bent by the voltage being applied between the fixed electrode 561 and the movable electrode 562 was given as an example, there is no limitation thereto. For example, the configuration may use an induction actuator in which a first induction coil is arranged instead of the fixed electrode 561, and a second induction coil or a permanent magnet is arranged instead of the movable electrode 562.

The configuration may further use a piezoelectric actuator instead of the electrostatic actuator 56. In this case, a lower electrode layer, a piezoelectric film, and an upper electrode layer are layered and arranged on the holding portion 522, and it is possible for the holding portion 522 to be bent by the piezoelectric film being expanded and compressed by a voltage applied between the lower electrode layer and the upper electrode layer being varied as an input value.

In the embodiment, although a variable wavelength interference filter 5 in which the fixed substrate 51 and the movable substrate 52 are bonded in a state of facing one another as a Fabry-Perot etalon, a fixed reflection film 54 is provided on the fixed substrate 51, and the movable reflection film 55 is provided on the movable substrate 52 was given as an example, there is no limitation thereto.

For example, a configuration may be used in which a gap modification portion, such as a piezoelectric element, that modifies the gap between reflection layers is provided between these substrates without the fixed substrate 51 and the movable substrate 52 being bonded.

There is no limitation to a configuration configured by two substrates. For example, a variable wavelength interference filter may be used in which two reflection films are layered interposing a sacrificial layer on one substrate, and a gap is formed by removing the sacrificial layer through etching or the like.

In the embodiment, although a diaphragm-like holding portion 522 was given as an example, a configuration may be used in which a plurality of holding portions with a beam structure is provided, and the movable portion 521 is held by these holding portions with a beam structure. In this case, because the bending balance of the holding portions with a beam like structure is made uniform, it is preferable to provide a holding portion with point symmetry with respect to a planar center point O.

In the embodiment, although a variable wavelength interference filter 5 capable of modifying the selected wavelength is given as an example of an interference filter, the invention is not limited thereto, and a Fabry-Perot filter in which only the predetermined wavelength of light is selectively extracted may be used.

Additionally, the specific structures when carrying out the invention may be configured by combining, as appropriate, the embodiments and modification examples in a range able to achieve the object of the invention, or other structures and the like maybe modified, as appropriate.

The entire disclosure of Japanese Patent Application No. 2014-095036, filed May 2, 2014 is expressly incorporated by reference herein.

What is claimed is:

1. An optical module comprising:
an interference filter that has a pair of reflection films facing one another, and that emits light with a wavelength according to the gap dimensions of the pair of reflection films;
a negative power lens group that guides an incident luminous flux to the interference filter; and
a positive power lens group on which a luminous flux passing through the interference filter is incident,
wherein the negative power lens group guides the incident luminous flux to the interference filter as a luminous flux in which a principal ray is parallel with respect to a central optical axis orthogonal to the pair of reflection films and which is scattered with respect to the principal ray, and
the positive power lens group makes the luminous flux scattered with respect to the principal ray a parallel luminous flux.

2. The optical module according to claim 1,
wherein the negative power lens group guides the luminous flux scattered within a predetermined angle with respect to the principal ray to the interference filter.

3. The optical module according to claim 2,
wherein the predetermined angle is 5 degrees.

4. An imaging system comprising:
an optical module that includes an interference filter that has a pair of reflection films facing one another, and that emits light with a wavelength according to the gap dimensions of the pair of reflection films, a negative power lens group that guides an incident luminous flux to the interference filter, and a positive power lens group on which a luminous flux passing through the interference filter is incident; and
an imaging device which includes an imaging element that images an image and an image forming optical system that images light from the optical module on the imaging element, and to which the optical module is detachably attached,
wherein the negative power lens group guides the incident luminous flux to the interference filter as a luminous flux in which a principal ray is parallel with respect to a central optical axis orthogonal to the pair of reflection films and which is scattered with respect to the principal ray, and
the positive power lens group makes the luminous flux scattered with respect to the principal ray a parallel luminous flux.
